(19) United States
(12) Patent Application Publication
(10) Pub. No.: US 2017/0115514 A1
(43) Pub. Date: Apr. 27, 2017

(54) CONTROL APPARATUS AND METHODS IN PHOTONICS APPLICATIONS

(71) Applicant: MOHAMMAD MEHDI MANSOURI RAD, KANATA (CA)

(72) Inventor: MOHAMMAD MEHDI MANSOURI RAD, KANATA (CA)

(73) Assignee: HUAWEI TECHNOLOGIES CO., LTD., Shenzhen (CN)

(21) Appl. No.: 14/921,529

(22) Filed: Oct. 23, 2015

(51) Int. Cl. G02F 1/01; G02B 6/42; G02B 6/28; G02B 6/35; G02F 1/17; G02F 1/225; G02F 1/313

(52) U.S. Cl. CPC G02F 1/0121; G02F 1/225; G02B 6/4286; G02F 1/313; G02B 6/3588; G02F 1/17; G02B 6/2861

(57) ABSTRACT

Control apparatus and methods for photonic devices are disclosed. One or more detectors is used to monitor a functional state of a photonic device. Each detector is configured to receive a respective pair of optical signals from the photonic device and generate a detection signal proportional to a difference between the pair of optical signals. A controller generates control signal(s) for the photonic device based on the detection signal(s). The apparatus and methods may be used in optical switching applications to control multiple photonic devices configured as optical switches in order to implement a multi-channel optical switch fabric for a multi-channel optical switch.

### FIELD OF THE APPLICATION

The application relates to photonics systems generally and more particularly to control apparatus and methods for photonic devices.

### BACKGROUND

In All Optical Networks (AONs), Data Centers, or other platforms that utilize Photonic Integrated Circuits (PICs), such as silicon photonics switches, it is often desirable to be able to perform routing, switching, monitoring and reliability checking on a per-channel basis in each segment of the network.

Each PIC element typically has a plurality of control signals associated with it that allow the PIC element to be controlled and monitored to achieve a desired operational point or state. For example, for the purpose of switching, the status of a PIC switching element may be monitored over time to assure performance or proper behavior in case of a fault or to account for changes due to aging and/or changes in the operational environment, such as ambient temperature.

A multi-channel AON switch may be realized using a switch fabric made up of multiple PIC switching elements. In order to increase switch fabric functionality, for example to provide additional degrees/directions of switching, the number of switching elements must typically be increased.

### SUMMARY

An aspect of the invention provides an apparatus that includes a photonic device and a detector operatively coupled to the photonic device. The detector is configured to receive a pair of optical signals from the photonic device and generate a detection signal proportional to a difference between the pair of optical signals. The photonic device has a control input to receive a control signal determined in accordance with the detection signal.

The apparatus may further include a controller operatively coupled to the detector and the control input of the photonic device. The controller may be configured to receive the detection signal and generate the control signal for the photonic device based on the detection signal.

In some embodiments, the photonic device is a Mach-Zehnder Interferometer (MZI) based photonic device.

In some such embodiments, the MZI based photonic device may include a first optical signal path arm and a second optical signal path arm. In such embodiments, the first optical signal path arm may include a controllable optical phase shifter. The controllable optical phase shifter may have a control input operatively coupled to the control input of the photonic device to receive the control signal from the controller. The controllable optical phase shifter may be configured to introduce a phase shift along the first optical signal path arm based on the control signal.

In some of the above embodiments, the controller may be configured to generate a second control signal for the photonic device based on the detection signal and the photonic device may have a second control input operatively coupled to the controller to receive the second control signal. The second control signal may be used to control a controllable optical phase shifter in the second optical signal path arm.

In some cases the photonic device is a Variable Optical Attenuator (VOA) with an optical input and an optical output. In these embodiments, the controller is configured to generate the control signal to control optical attenuation between the optical input and the optical output of the VOA.

In another embodiment, the apparatus also includes a second detector operatively coupled to the photonic device. In this embodiment, the second detector is configured to receive a second pair of optical signals from the photonic device and generate a second detection signal proportional to a difference between the second pair of optical signals. In these embodiments, the controller is operatively coupled to the second detector to receive the second detection signal, and is configured to generate the control signal based on the detection signals from both detectors.

In some of the above embodiments, the photonic device is configured as an optical switch.

In one embodiment the photonic device is configured as a 1×2 optical switch having a first optical input, a first optical output, and a second optical output.

In some such embodiments, the first detector is operatively coupled between the first optical input and the first optical output of the 1×2 optical switch, and is configured to generate the first detection signal proportional to a difference between a first optical input signal at the first optical input and a first optical output signal at the first optical output. Similarly, the second detector is operatively coupled between the first optical input and the second optical output of the 1×2 optical switch, and is configured to generate the second detection signal proportional to a difference between the first optical input signal at the first optical input and a second optical output signal at the second optical output.

In some embodiments, to operate the 1×2 optical switch in an up-state, the controller is configured to adjust the control signal based on the first detection signal, and to operate the 1×2 optical switch in a down-state, the controller is configured to adjust the control signal based on the second detection signal.

In other embodiments, the photonic device is configured as a 2×2 optical switch having a first optical input, a second optical input, a first optical output and a second optical output.

In some such embodiments, the first detector is operatively coupled between the first optical input and the first optical output of the 2×2 optical switch, and is configured to generate the first detection signal proportional to a difference between a first optical input signal at the first optical input and a first optical output signal at the first optical output. Similarly, the second detector is operatively coupled between the second optical input and the second optical output of the 2×2 optical switch, and is configured to generate the second detection signal proportional to a difference between a second optical input signal at the second optical input and a second optical output signal at the second optical output.

In some embodiments, to operate the 2×2 optical switch in a bar-state, the controller is configured to adjust the control signal based on the first detection signal and/or the second detection signal, and to operate the 2×2 optical switch in a cross-state, the controller is configured to adjust the control signal based on a difference between the first detection signal and the second detection signal.

In another embodiment, the first detector is operatively coupled between the first optical input and the second optical input, and is configured to generate the first detection signal proportional to a difference between a first optical input signal at the first optical input and a second optical input signal at the second optical input. Similarly, in this embodiment the second detector is operatively coupled between the first optical output and the second optical output, and is configured to generate the second detection signal proportional to a difference between a first optical output signal at the first optical output and a second optical output signal at the second optical output.

In some embodiments the detector is implemented with a first photodetector and a second photodetector arranged in a back-to-back biasing arrangement with the detection signal being taken as an output current at a point between the first photodetector and the second photodetector with the output current proportional to the difference between photocurrents generated by the first and second photodetectors.

In some embodiments, the apparatus further includes first and second optical taps. The first optical tap is operatively coupled to the photonic device and the first photodetector, and is configured to tap off a portion of a first optical signal onto an optical signal path between the first optical tap and the first photodetector. The second optical tap is operatively coupled to the photonic device and the second photodetector, and is configured to tap off a portion of a second optical signal onto an optical signal path between the second optical tap and the second photodetector.

In some of the above embodiments, the apparatus also includes a delay element in the optical signal path between the first optical tap and the first photodetector to at least partially account for a delay between the first optical signal and the second optical signal. In one embodiment, the delay element is implemented by making the optical signal path between the first optical tap and the first photodetector longer than the optical signal path between the second optical tap and the second photodetector.

In some embodiments, the apparatus is implemented in a multi-layer stack in which the controller is implemented on a layer above the photonic device and the detector.

Another aspect of the present invention provides a photonic integrated circuit (PIC) element that includes an apparatus according to the above aspect of the present invention.

A further aspect of the present invention provides a multi-channel optical switch that includes a multi-channel optical switch fabric that includes multiple PIC elements according to the above aspect of the present invention.

Still another aspect of the present invention provides a method to control a photonic device. The method includes receiving, at a detector, a pair of optical signals from a photonic device, generating, with the detector, a detection signal proportional to a difference between the pair of optical signals from the photonic device, and generating a control signal for the photonic device based on the detection signal.

In some embodiments, the photonic device may be a Mach-Zehnder Interferometer (MZI) based photonic device that has a pair of optical signal path arms, with a controllable phase shifter in at least one of the optical signal path arms. In such embodiments, generating a control signal may include generating at least one control signal to control the controllable phase shifter(s) to introduce a relative phase shift between the optical signal path arms of the MZI based photonic device.

In some embodiments, the photonic device may be a Variable Optical Attenuator (VOA) with an optical input and an optical output. In these embodiments, generating the control signal may include adjusting the control signal to control optical attenuation between the first optical input and the first optical output.

In another embodiment, the detector that generates the detection signal is a first detector, the pair of optical signals from the photonic device is a first pair of optical signals, and the detection signal generated by the first detector is a first detection signal. In some such embodiments, the method further includes receiving, at a second detector, a second pair of optical signals from the photonic device, generating, with the second detector, a second detection signal proportional to a difference between the second pair of optical signals from the photonic device. In such cases, generating a control signal may involve generating at least one control signal based on the first detection signal and the second detection signal.

In some embodiments, the photonic device may be configured as a 1×2 optical switch with a first optical input, a first optical output and a second optical output. In some such cases, the first detector is coupled between the first optical input and the first optical output to generate the first detection signal proportional to a difference between a first optical input signal from the first optical input and a first optical output signal from the first optical output. Similarly, the second detector may be coupled between the first optical input and the second optical output to generate the second detection signal proportional to a difference between the first optical input signal from the first optical input and a second optical output signal from the second optical output.

In some embodiments, where the photonic device is configured as a 1×2 optical switch, the method further includes selectively switching the 1×2 optical switch between an up-state and a down-state by adjusting the control signal based on the first detection signal to operate the 1×2 optical switch in the up-state, and adjusting the control signal based on the second detection signal to operate the 1×2 optical switch in the down-state.

In some embodiments, the photonic device may be configured as a 2×2 optical switch with a first optical input, a first optical output, a second optical input and a second optical output. In some such embodiments, the first detector is coupled between the first optical input and the first optical output to generate the first detection signal proportional to a difference between a first optical input signal from the first optical input and a first optical output signal from the first optical output. Similarly, the second detector may be coupled between the second optical input and the second optical output to generate the second detection signal proportional to a difference between a second optical input signal from the second optical input and a second optical output signal from the second optical output.

In some embodiments, where the photonic device is configured as a 2×2 optical switch, the method further includes selectively switching the 2×2 optical switch between a bar-state and a cross-state by adjusting the control signal based on the first detection signal and/or the second detection signal to operate the 2×2 optical switch in the bar-state, and adjusting the control signal based on a difference between the first detection signal and the second detection signal to operate the 2×2 optical switch in the cross-state.

In another embodiment, generating the detection signal with the detector includes tapping off a portion of a first optical signal from the photonic device onto a first optical signal path to the detector, and tapping off a portion of a second optical signal from the photonic device onto a second optical signal path to the detector. In this embodiment, generating the detection signal with the detector includes generating a detection signal that is proportional to a difference between the tapped off portion of the first optical signal and the tapped off portion of the second optical signal.

In some cases, the method 600 may further include delaying the tapped off portion of the first optical signal relative to the tapped off portion of the second optical signal to at least partially account for a delay between the first optical signal and the second optical signal.

### BRIEF DESCRIPTION OF THE DRAWINGS

Embodiments will now be described with reference to the attached drawings in which:

FIG. 1A is a logical block diagram of an apparatus for controlling a 1×1 photonic device in accordance with an embodiment of the invention;

FIG. 1B is a logical block diagram of an apparatus for controlling a 2×2 photonic device in accordance with an embodiment of the invention;

FIG. 1C is a logical block diagram of another apparatus for controlling a 2×2 photonic device in accordance with an embodiment of the invention;

FIG. 2 is a block diagram of an example of a detector in accordance with an embodiment of the invention;

FIG. 3 is a logical block diagram of an apparatus for controlling a 1×2 photonic device in accordance with an embodiment of the invention;

FIG. 4 is a logical block diagram of the apparatus of FIG. 1B with additional example implementation details of the 2×2 photonic device;

FIG. 5A is a plot showing the total number of optical monitoring and control signals vs. switch fabric size for a 4 degree AON PIC switch with 50% add drop capacity for a control scheme in accordance with an embodiment of the present disclosure and for a conventional control scheme;

FIG. 5B is a plot based on the plot of FIG. 5A showing the percent reduction in the number of optical monitoring and control signals vs. switch fabric size for the control scheme relative to the conventional control scheme; and

FIG. 6 is a flowchart of an example method in accordance with an embodiment of the present invention.

### DETAILED DESCRIPTION OF EMBODIMENTS

Integrating a large number of PIC elements into a multi-channel switch fabric can be challenging in terms of routing the monitoring and control signals (optical and electrical) that allow the operation of each PIC element to be individually monitored and controlled. Furthermore, optical monitoring signals may create signal leakage, and routing such signals may be a significant challenge when trying to avoid or limit waveguide crossing within a switch and overall throughout a switch fabric. Also, the overall footprint of each PIC element, and possibly power consumption, may be increased when more signals have to be routed between the element and its respective controller.

Aspects of the present invention utilize detectors configured to produce differential monitoring signals that are routed between a photonic device, such as a PIC element, and its associated controller.

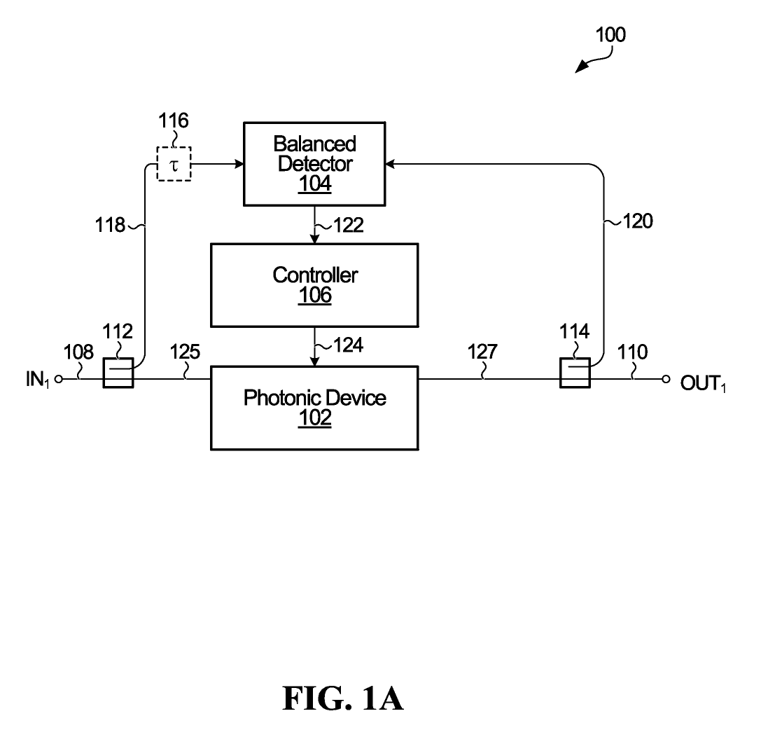

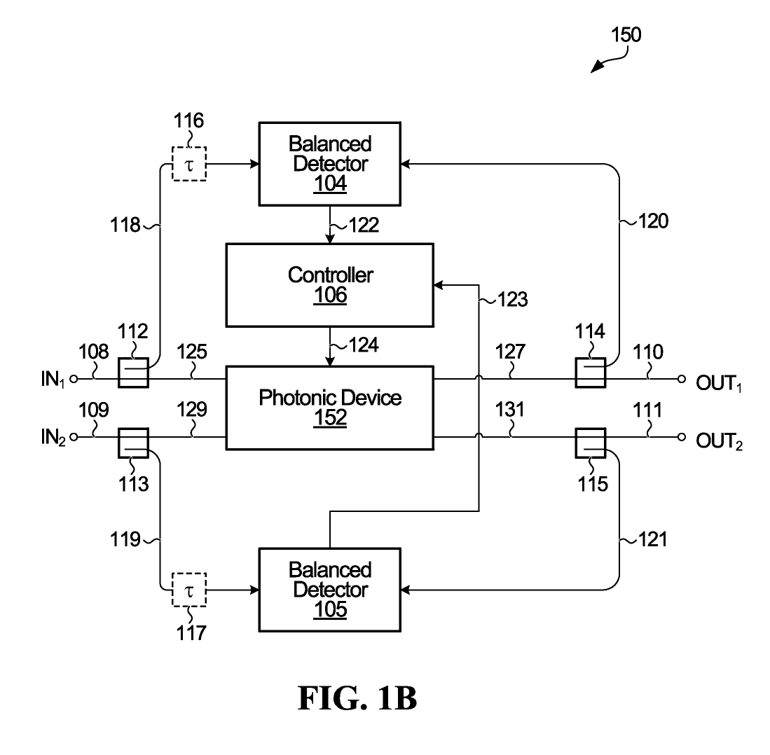

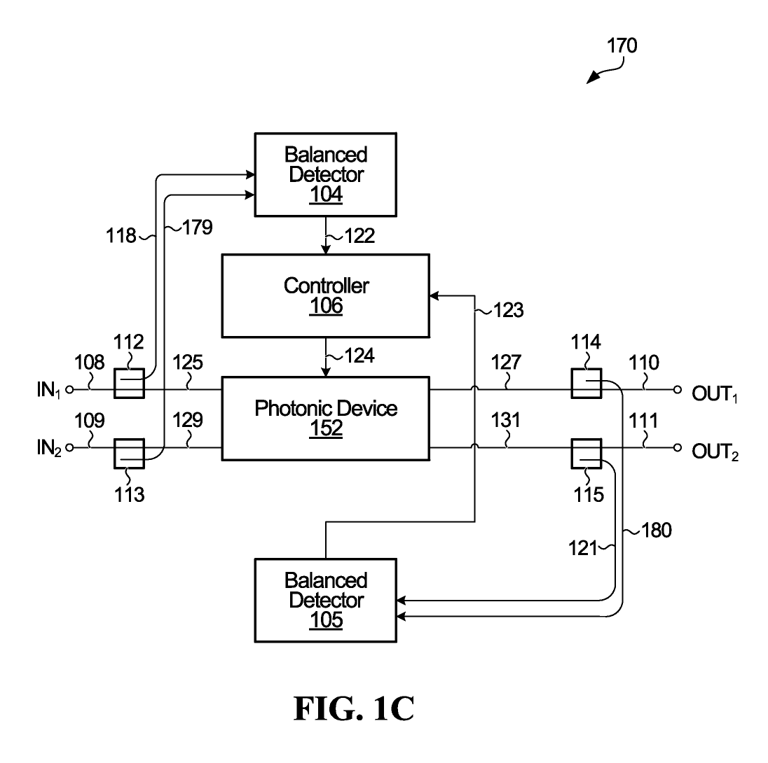

FIG. 1A is a logical block diagram of an example apparatus in accordance with an embodiment of the present disclosure. The apparatus 100 includes an optical input 108, a first optical tap 112, a photonic device 102, a detector 104, a controller 106, a second optical tap 114, and an optical output 110. In the example of FIG. 1A, the photonic device 102 is a 1×1 photonic device in the sense that it has one optical input 125 and one optical output 127. It also receives a control signal 124.

Optical input 108 is coupled to an optical input of first optical tap 112. A first optical output of first optical tap 112 is coupled to a first optical input of detector 104 through a first optical signal path 118. A second optical output of first optical tap 112 is coupled to the optical input 125 of photonic device 102. The optical output 127 of photonic device 102 is coupled to an optical input of second optical tap 114. A first optical output of optical tap 114 is coupled to a second optical input of detector 104 through a second optical signal path 120. A second optical output of second optical tap 114 is coupled to optical output 110. Controller 106 has an input operatively coupled to detector 104, and an output operatively coupled to a control input of photonic device 102.

In operation, first optical tap 112 taps off a portion of an optical input signal received at optical input 108 onto optical signal path 118 between first optical tap 112 and detector 104. The remaining portion of the optical input signal passes to optical input 125 of photonic device 102.

Photonic device 102 implements some photonic function on the portion of the optical input signal passed to optical input 125 by first optical tap 112, resulting in an optical output signal at optical output 127. The photonic function implemented by photonic device 102 is controlled by a control signal 124 generated by controller 106. Although control signal 124 is depicted as a single signal, more generally, in this and other embodiments described herein, there may be one or multiple connections carrying control signaling from the controller to a photonic device.

In general, a control signal may be any signal that affects one or more operational metrics of the photonic device to modulate one or more of the properties of an optical signal, such as intensity, phase, or polarization, for example.

Second optical tap 114 taps off a portion of the optical output signal from optical output 127 of photonic device 102 onto optical signal path 120 between second optical tap 114 and detector 104. Second optical tap 114 also passes the remaining portion of the optical output signal from optical output 127 to the optical output 110.

Detector 104 generates a detection signal 122 proportional to a difference between the tapped off portion of the optical input signal from first optical tap 112 and the tapped off portion of the optical output signal from second optical tap 114.

Controller 106 receives detection signal 122 from detector 104 and generates control signal 124 for photonic device 102 to establish and maintain photonic device 102 in a desired functional state. For example, in some embodiments photonic device 102 may be configured as a Variable Optical Attenuator (VOA), and controller 106 may be configured to adjust control signal 124 so that the detection signal 122 indicates a desired level of optical attenuation between the optical input 108 and the optical output 110.

Photonic device 102 and optical taps 112 and 114 may be implemented in a silicon photonics fabrication technology in some embodiments. Controller 106 may be implemented in a semiconductor technology, such as Complementary Metal-Oxide Semiconductor, for example.

In some embodiments, the apparatus 100 may be implemented in a multi-layer stack with controller 106 implemented on a layer above photonic device 102, detector 104, and optical taps 112 and 114. For example, controller 106 may be mounted on a pillar so that it is offset vertically in another layer above photonic device 102. Such a multi-layer stack arrangement may be beneficial in applications such as 2.5D interposers, 3D interposers in high performance computing, server and datacom applications.

The ratio of the portion of the optical signal that is tapped off versus passed on by each of the optical taps is an implementation specific detail. In some embodiments the optical taps may be 98/2 or 97/3 optical taps, where 2% or 3% of an optical signal received at the optical input of the optical tap is tapped off and 98% or 97% is passed on. In other embodiments, the ratio may be higher or lower than this. For example, depending on the performance (e.g. quantum efficiency and dark current) of the components used in the detector to detect the tapped off portion of the optical signals, higher tap ratios such as 99/1 may be used.

A link budget is an accounting of losses experienced by an optical signal along its propagation path between a source and a destination. Each optical tap diverts part of the optical power of an optical signal, which contributes to the overall loss experienced by the optical signal, and hence affects the link budget. Therefore, it is generally desirable to use higher tap ratios to minimize the loss experienced at each tap. In practice, there is typically a trade-off between the tap ratio and certainty in readings due to noise. In other words, reducing the amount of power in the tapped off portion of the optical signal may require a more expensive and/or more complex detector in order to be able to reliably detect the tapped off portion of the optical signal. For example, a detector with a higher dynamic range may be needed when an optical tap with a higher optical tap ratio is used.

Detector 104 may be implemented by any differential sensing structure that is configured to generate a detection signal proportional to a difference between a pair of optical signals.

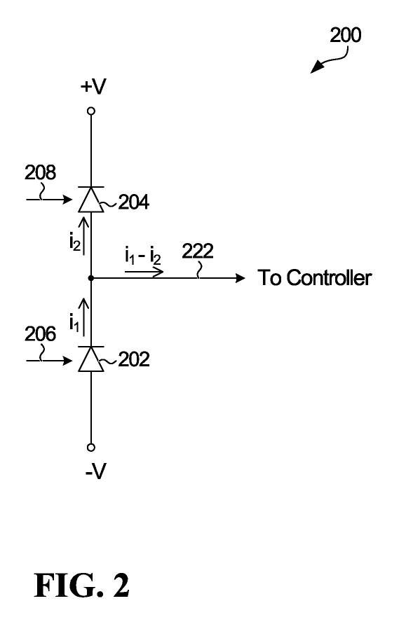

FIG. 2 is a block diagram of an example of a detector 200 that may be used in some embodiments.

Detector 200 includes a first photodetector 202 and a second photodetector 204 arranged in a back-to-back biasing arrangement between +V and −V biasing voltages. The output current at a point between first photodetector 202 and second photodetector 204 is output as a detection signal 222.

In operation, first photodetector 202 generates a first electrical current i₁ that is proportional to a first optical signal 206 incident on first photodetector 202. Similarly, second photodetector 204 generates a second electrical current i₂ that is proportional to a second optical signal 208 incident on second photodetector 204. Detection signal 222 is then produced as the difference i₁−i₂ between the first electrical current i₁ and the second electrical current i₂, which is proportional to a difference between first optical signal 206 and second optical signal 208.

The detector 200 shown in FIG. 2 may be referred to as a balanced detector, because the two photodetectors 202 and 204 are connected such that their photocurrents cancel when the optical signals incident upon them are equal, meaning that the effective output of the balanced pair of photodetectors is zero until there is some difference between the pair of incident optical signals. When this occurs, it causes the pair of photodetectors to become “unbalanced” and a net signal proportional to the difference is generated at the output of the detector.

In some embodiments, controller 106 provides amplification and noise reduction to the detected current of the detection signal. For example, controller 106 may include TransImpedance Amplifiers (TIAs) and Operational Amplifiers (OpAmps) to further improve the signal quality of the detected current of the detection signal for processing.

Photodetectors 202 and 204 may be implemented by any component that is capable of sensing an optical signal and generating an electrical current. For example, in some embodiments each of photodetectors 202 and 204 may be implemented with a PIN (P-type Intrinsic N-type semiconductor) diode.

In some embodiments, photodetectors 202 and 204 may be integrated with a photonic device as part of a PIC element.

Referring again to FIG. 1A, in some embodiments the apparatus 100 further includes a delay element 116 in optical signal path 118 between first optical tap 112 and detector 104 to at least partially account for a delay between the portion of the optical input signal tapped off at the first optical tap 112 and the portion of the optical output signal tapped off at the second optical tap 114. Such a delay arises due to the difference in optical path lengths between the signal path 118 and the signal paths 125, 127, 120. In other embodiments, the difference in optical path lengths may be sufficiently small that the delay element 116 is not needed.

In some embodiments, delay element 116 may be implemented by making the optical signal path 118 longer than the optical signal path 120. For example, detector 104 may be arranged so that it is closer to the optical output 127 of photonic device 102. However, due to optical and electrical cross talk considerations, for example, it may not be possible or practical to arrange the detector so that it is closer to the optical output of the photonic device. In general, the detector and/or controller may be geographically localized anywhere in relation to the photonic device on a PIC chip. In some cases, waveguides with different shapes may be used to increase the optical signal path. In some embodiments, delay element 116 may be implemented as a variable delay element that, for example, manipulates the refractive index of a waveguide.

Referring now to FIG. 1B, shown is a logical block diagram of an example apparatus 150 in accordance with an embodiment of the present disclosure. The apparatus 150 includes all of the components of FIG. 1A, identically referenced except for photonic device 152 which is a 2×2 photonic device with two optical inputs 125,129 and two optical outputs 127,131. In addition, apparatus 100 further includes a second optical input 109, a third optical tap 113, a second detector 105, a fourth optical tap 115, and a second optical output 111.

In this configuration, optical input 108 is coupled to the optical input 125 of photonic device 152. The optical output 127 of photonic device 102 is coupled to optical output 110. Optical input 109 is coupled to the optical input 129 of photonic device 152. The optical output 131 of photonic device 102 is coupled to optical output 111.

First optical tap 112 is coupled to the optical input 108. Second optical tap 114 is coupled to the optical output 110. First detector 104 has first and second optical inputs respectively coupled to second optical outputs of the first and second optical taps 112 and 114 through first and second optical signal paths 118 and 120. Similarly, third optical tap 113 is coupled to the optical input 109. Fourth optical tap 115 is coupled to the optical output 111. Second detector 105 has first and second optical inputs respectively coupled to second optical outputs of the third and fourth optical taps 113 and 115 through first and second optical signal paths 119 and 121.

Controller 106 has a first input operatively coupled to first detector 104, a second input operatively coupled to second detector 105, a first output operatively coupled to a first control input of photonic device 152, and a second output operatively coupled to a second control input of photonic device 152.

In operation, third optical tap 113, second detector 105 and fourth optical tap 115 function in the same manner as first optical tap 112, first detector 104 and second optical tap 114 discussed above.

In this configuration, photonic device 152 includes two optical inputs 125 and 129 and two optical outputs 127 and 131, and implements some photonic function on the portion of a first optical input signal passed to optical input 125 by first optical tap 112 or on the portion of a second optical input signal passed to optical input 129 by third optical tap 113, resulting in an optical output signal at optical output 127 or at optical output 131. In this configuration, controller 106 receives first detection signal 122 from first detector 104 and second detection signal 123 from second detector 105, and generates control signal 124 for photonic device 152 based on first detection signal 122 and second detection signal 123 to place photonic device 152 in a desired functional state.

In some embodiments photonic device 152 may be configured as a 2×2 optical switch, and controller 106 may be configured to generate control signal 124 to selectively operate the 2×2 optical switch of photonic device 152 in either a bar-state, in which an optical signal received at the first optical input 125 is switched to the first optical output 127 and an optical signal received at the second optical input 129 is switched to the second optical output 131, or a cross-state, in which an optical signal received at the first optical input 125 is switched to the second optical output 131 and an optical signal received at the second optical input 129 is switched to the first optical output 127.

In some embodiments, the system in which the apparatus 150 is used is configured such that only one of the optical inputs 108 and 109 of the apparatus 150 receives an optical input signal at a time. In some such embodiments, in order to operate the 2×2 optical switch of photonic device 152 in the bar-state, the controller 106 may be configured to adjust control signal 124 based on the first detection signal 122 and/or the second detection signal 123, and in order to operate the 2×2 optical switch of photonic device 102 in the cross-state the controller 106 may be configured to adjust control signal 124 based on a difference between the first detection signal 122 and the second detection signal 123. More generally, controller 106 may be configured to adjust control signal 124 based on at least one of the detection signals 122 and 123 to place photonic device 152 in a desired functional state.

In an ideal bar-state, the 2×2 optical switch of photonic device 102 would switch all of an optical input signal received at its first optical input 125 to its first optical output 127, and would switch all of an optical input signal received at its second optical input 129 to its second optical output 131. Similarly, in an ideal cross-state, the 2×2 optical switch of photonic device 102 would switch all of an optical input signal received at its first optical input 125 to its second optical output 131, and would switch all of an optical input signal received at its second optical input 129 to its first optical output 127.

In some cases, to achieve good signal isolation (i.e., low cross talk), each switch or other photonic device is used with at most one input signal at a time. For example, in order to achieve certain performance metrics, such as cross talk levels, many Wavelength-Division Multiplexing (WDM) switches for Metro and Data Center (DC) applications utilize switch fabrics composed of switch cells that operate on the assumption that only a single optical signal at a time passes through each switch cell. In this case, the bar-state corresponds to minimizing the detection signals 122 and 123 so that each output 110, 111 most closely matches the input 108, 109 on its respective path. The cross-state corresponds to minimizing the difference between the detection signals 122 and 123, so that one of the outputs 110, 111 most closely matches the opposite input 109, 108. Therefore, by using detection, both the cross-state and the bar-state can potentially be controlled using a relatively simple and straightforward control algorithm based on the detection signals.

In some embodiments controller 106 may be configured to implement an algorithm that adjusts control signal 124 in an effort to minimize the first detection signal 122 and/or the second detection signal 123 in order to operate in the bar-state, and adjusts control signal 124 in an effort to minimize a difference between the first detection signal 122 and the second detection signal 123 in order to operate in the cross-state.

In some embodiments, a delay element 117 is included in optical signal path 119 between third optical tap 113 and second detector 105 for the same reasons that a delay element 116 may be included in optical signal path 118 between first optical tap 113 and first detector 104. In some embodiments, the delay elements 116 and 117 are configured to introduce an equal delay. However, in some cases they may be configured to introduce unequal delays.

FIG. 1C is a logical block diagram of an example apparatus 170 for controlling a 2×2 photonic device 152. Apparatus 170 differs from apparatus 150 of FIG. 1B in that in apparatus 170 the second optical output of third optical tap 113 is coupled to the second optical input of the first detector 104 through optical signal path 179, rather than coupled to the first optical input of the second detector 105 through optical signal path 119, and in that the second optical output of the second optical tap 114 is coupled to the first optical input of the second detector 105 through optical signal path 180, rather than coupled to the second optical input of the first detector 104 through optical signal path 120.

In operation, the optical taps 112, 113, 114 and 115 and the detectors 104 and 105 function in the same manner as discussed above with reference to FIG. 1B. However, in this configuration, the first detection signal 122 received by controller 106 from first detector 104 is proportional to a difference between the tapped off portions of the input optical signals received at optical inputs 108 and 109, and the second detection signal 123 received by controller 106 from second detector 105 is proportional to a difference between the tapped off portions of the optical output signals from optical outputs 127 and 131 of photonic device 152. As in the previous embodiment, in this configuration the controller 106 also generates control signal 124 for photonic device 152 based on first detection signal 122 and second detection signal 123 to place photonic device 152 in a desired functional state.

It is noted that delay elements 116 and 117 have been omitted in FIG. 1C, because in this configuration there is typically no non-negligible delay to be accounted for between the optical inputs of a detector.

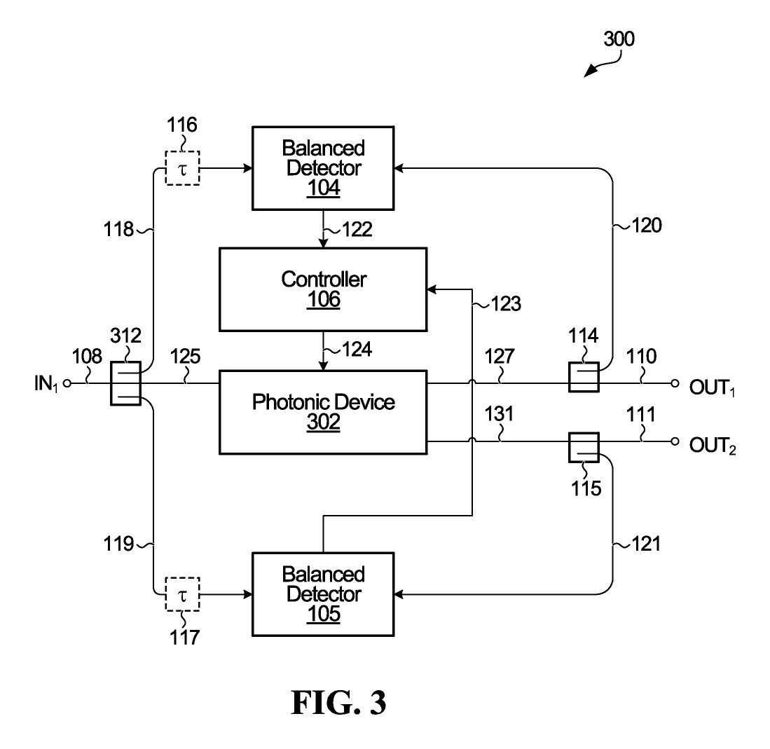

An apparatus for controlling a 1×2 (one optical input and two optical outputs) photonic device will now be discussed with reference to FIG. 3.

FIG. 3 is a logical block diagram of an apparatus 300 for controlling a 1×2 photonic device 302. Apparatus 300 differs from apparatus 150 shown in FIG. 1B only in that the second optical input 109 and the third optical tap 113 have been omitted and the first optical tap 112, which was a three port optical tap, has been replaced with a four port optical tap 312, and the optical signal path 119 is coupled between a third optical output of optical tap 312 and the first optical input of second detector 105.

In operation, the optical tap 312 taps off a first portion of an optical input signal received at optical input 108 onto optical signal path 118 between optical tap 312 and first detector 104, and also taps off a second portion onto optical signal path 119 between optical tap 312 and second detector 105. Optical tap 312 also passes a remaining portion of the optical input signal to optical input 125 of photonic device 302.

Second optical tap 114, third optical tap 113, first detector 104, second detector 105 and fourth optical tap 115 of apparatus 300 function in the same manner as the correspondingly numbered components of apparatus 150 discussed above.

Photonic device 302 includes one optical input 125 and two optical outputs 127 and 131, and implements some photonic function on the portion of the optical input signal passed to optical input 125 by first optical tap 312, resulting in an optical output signal at optical output 127 or at optical output 131. The photonic function implemented by photonic device 302 is controlled by control signal 124 generated by controller 106, which receives first detection signal 122 from first detector 104 and second detection signal 123 from second detector 105, and generates control signal 124 for photonic device 302 based on first detection signal 122 and second detection signal 123 to place photonic device 302 in a desired functional state.

In some embodiments photonic device 302 may be a 1×2 optical switch, and controller 106 may be configured to generate control signal 124 to selectively operate the 1×2 optical switch of photonic device 302 in either an up-state, in which an optical signal received at the first optical input 125 is switched to the first optical output 127, or a down-state, in which an optical signal received at the first optical input 125 is switched to the second optical output 131.

In some embodiments, in order to operate the 1×2 switch of photonic device 302 in the up-state, controller 106 is configured to adjust control signal 124 based on the first detection signal 122, and in order to operate the 1×2 switch of photonic device 302 in the down-state, controller 106 is configured to adjust control signal 124 based on the second detection signal 123. More generally, controller 106 may be configured to adjust control signal 124 based on the first detection signal 122, the second detection signal 123, or both, in order to place photonic device 302 in a desired functional state.

In an ideal up-state, the 1×2 optical switch of photonic device 302 would switch all of an optical input signal received at optical input 125 to its first optical output 127. Similarly, in an ideal down-state, the 1×2 optical switch of photonic device 302 would switch all of an optical input signal received at optical input 125 to its second optical output 131. As such, in the ideal up-state the first detection signal 122 would be minimized, and in the ideal down-state the second detection signal 123 would be minimized, because the first detection signal 122 is proportional to a difference between the signal at optical signal path 108 and the signal at optical signal path 110; and the second detection signal 123 is proportional to a difference between the signal at optical signal path 108 and the signal at optical signal path 111.

In some embodiments controller 106 may be configured to implement an algorithm that adjusts control signal 124 to minimize the first detection signal 122 in order to operate in the up-state, and adjusts control signal 124 to minimize the second detection signal 123 in order to operate in the down-state.

Similarly to the apparatus 150 of FIG. 1B, in some embodiments the apparatus 300 of FIG. 3 may include delay elements 116 and 117 in the optical signal paths 118 and 119, respectively.

Although FIG. 3 shows an example of an apparatus for controlling a 1×2 photonic device, in some embodiments a similar arrangement is used to control a 2×1 photonic device having two optical inputs and one optical output.

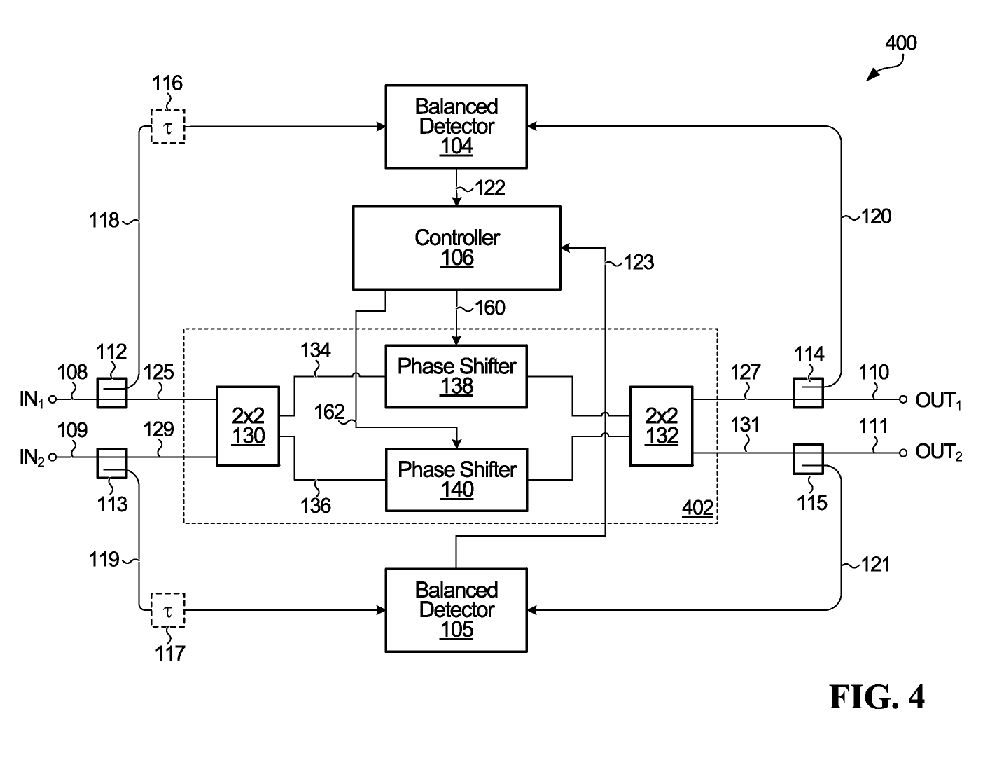

In some embodiments, the photonic devices 102 and 302 may be Mach-Zehnder Interferometer (MZI) based photonic devices. Although embodiments of the present disclosure are in no way limited to only MZI based photonic devices, for illustrative purposes an example implementation of the photonic device 102 of FIG. 1 using an MZI based photonic device will now be described with reference to FIG. 4.

FIG. 4 is a logical block diagram of the apparatus of FIG. 1B with the 2×2 photonic device 152 implemented using an MZI based photonic device 402.

The apparatus 400 of FIG. 4 is otherwise the same as the apparatus 150 of FIG. 1B, with the exception that in FIG. 4 the control signal 124 of FIG. 1B is implemented as two control signals 160 and 162.

The 2×2 MZI based photonic device 402 includes a first 2×2 directional coupler 130, a first optical signal path arm 134 that includes a first controllable optical phase shifter 138, a second optical signal path arm 136 that includes a second controllable optical phase shifter 140, and a second 2×2 directional coupler 132.

The first 2×2 directional coupler 130 has a first optical input coupled to the optical input 125 of photonic device 302, and a second optical input coupled to the second optical input 129 of photonic device 302. The first 2×2 directional coupler 130 also has a first optical output coupled to one end of first optical signal path arm 134, and a second optical output coupled to one end of second optical signal path arm 136. The other ends of first optical signal path arm 134 and second optical signal path arm 136 are coupled to first and second optical inputs of second 2×2 directional coupler 132. Second 2×2 directional coupler 132 also has first and second optical outputs coupled to the first and second optical outputs 127 and 131 of photonic device 402, respectively.

Controllable optical phase shifters 138 and 140 each have a control input coupled to controller 106 to receive respective control signals 160 and 162.

In operation, the optical taps 112, 113, 114 and 115 and the detectors 104 and 105 function as described above with reference to FIG. 1. Controller 106 also functions as described above, and generates the control signals 160 and 162 to control the phase shifters 138 and 140, which introduce a relative phase shift between the optical signal path arms 134 and 136 in response to the control signals 160 and 162 to place photonic device 402 in a desired functional state.

The operation of MZI based photonic devices is well known, and therefore the theory behind that operation will not be discussed here in detail, as it should be apparent to a person of skill that a relative phase shift between the optical signal path arms of a MZI based photonic device results in either constructive or destructive interference when the optical signals that have been coupled onto each optical signal arm by the first 2×2 directional coupler 130 are combined through the second 2×2 directional coupler 132 to produce optical output signals at the optical outputs 127 and 131. This selective constructive/destructive interference allows an MZI based photonic device to function as an optical switch, for example.

For example, the phase shifters 138 and 140 can be controlled to operate the MZI based photonic device 102 in a bar-state by introducing a first relative phase shift between the optical signaling arms 134 and 136 that results in constructive interference at the first optical output 127 and destructive interference at the second optical output 131 for an optical input signal received at the first optical input 125, and destructive interference at the first optical output 127 and constructive interference at the second optical output 131 for an optical input signal received at the second optical input 129.

Similarly, the phase shifters 138 and 140 can be controlled to operate the MZI based photonic device 102 in a cross-state by introducing a different relative phase shift between the optical signaling arms 134 and 136 that results in destructive interference at the first optical output 127 and constructive interference at the second optical output 131 for an optical input signal received at the first optical input 125, and constructive interference at the first optical output 127 and destructive interference at the second optical output 131 for an optical input signal received at the second optical input 129.

As such, it should be apparent that, in some embodiments, the MZI based photonic device 402 may be configured to operate as a 2×2 optical switch in the bar and cross states discussed above with reference to FIG. 1B.

Similarly, it should be apparent that, in some embodiments, the 1×2 photonic device 302 of the apparatus 300 shown in FIG. 3 may be implemented with an MZI based photonic device, and may be configured as a 1×2 optical switch with the up-state and the down-state of the switch established by introducing relative phase shifts between the arms of the MZI based photonic device as described above.

In some embodiments, the 1×1 photonic device 102 of the apparatus 100 shown in FIG. 1A may also be implemented with an MZI based photonic device, and could be configured as a VOA with the variable attenuation established by adjusting the relative phase shift between the arms so that a selective amount of the optical input signal received at its optical input is passed to its optical output.

Although the MZI based photonic device 402 shown in FIG. 4 includes a controllable optical phase shifter in both optical signal arms of the MZI based photonic device, in other embodiments only one of the optical signal arms includes a controllable optical phase shifter.

In some embodiments, a controllable optical phase shifter may be implemented with a thermo-optical phase shifter or a carrier injection optical phase shifter.

In some embodiments, the directional couplers of the MZI based photonic device are implemented with multimode interference (MMI) couplers. In other embodiments, they may be implemented with adiabatic couplers.

In some embodiments, the example apparatuses are implemented as photonic integrated circuit (PIC) elements. Such PIC elements can then be arranged to form a multi-channel optical switch fabric. For example, in some embodiments, PIC elements that implement multiple 1×2, 2×1 and/or 2×2 optical switches are cascaded to implement a complex optical switching functionality.

In some embodiments, a PIC element may be implemented in a multi-layer stack with the controller for the PIC element implemented in a semiconductor technology, such as CMOS, and the photonic devices implemented in a photonic active chip, such as a silicon photonic active chip on a layer beneath the controller. In some embodiments, multiplexing/demultiplexing and interconnect functionality may be implemented in a third layer on another photonic chip, such a silicon-nitride (SiN) photonic chip, beneath the silicon photonic active chip.

In some embodiments, the semiconductor chip that includes the controller for the PIC element may be located in the same layer as the photonic active chip that includes the PIC element. In either case, using detection strategies as described herein between the controller and the PIC element may benefit the overall design.

From the foregoing examples, it can be seen that the number of monitoring signals that must be routed to a PIC element's associated controller can be reduced by using the detection strategies described herein.

For example, referring again to FIG. 4, the controller 106 is able to monitor the functional state of 2×2 photonic device 152 by receiving the two detection signals 122 and 123.

In contrast, if each of the two optical inputs 108 and 109 and the two optical outputs 110 and 111 were monitored individually, then four monitoring signals would have had to be routed to controller 106. In this example, the use of the detectors 104 and 105 in a 2×2 optical switch element may reduce the number of monitoring signals routed to the controller 106 from four to two.

In the case of a 2×1 or 1×2 optical switch element, such as the 1×2 photonic device 302 shown in FIG. 3, it should be appreciated that the use of the detectors 104 and 105 may reduce the number of monitoring signals routed to the controller 106 from three to two. The use of the detection strategies described herein also has a potential benefit for non-switching photonic devices. For example, for a photonic device configured as a VOA with one optical input and one optical output, the use of the detection strategies described herein may reduce the number of monitoring signals from two to one.

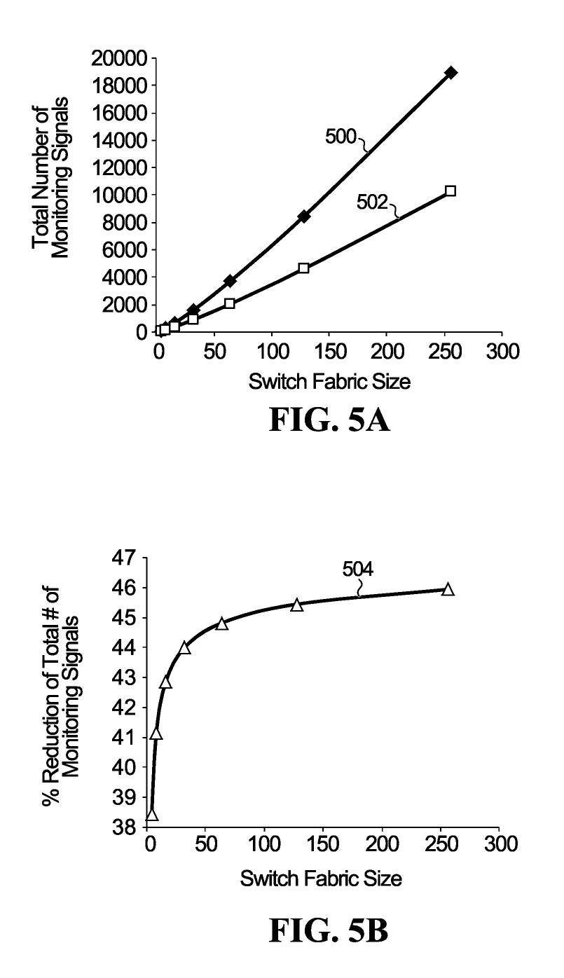

FIGS. 5A and 5B are plots illustrating the potential reduction in the number of monitoring and control signals that may be possible by utilizing the detection strategies described herein in an Hybrid Dilated Benes with Enhanced dilated banyan (HDBE) architecture switch fabric for a 4 degree AON PIC switch with 50% add drop capacity. The results plotted in FIGS. 5A and 5B, and the following discussion of those results, relate to a particular example implementation and are provided for illustrative purposes only. It is to be understood that these results are specific to the particular example, and other different results are possible with other different switch architectures and implementations.

HDBE is a modular architecture of 2×2/1×2/2×1 switch cells which has been used widely in the switch fabric architectures for AON, data centers, high performance computing, etc. It reflects an improved version of Benes switches which are well known basic architectures in switch design.

Without the use of the detection strategies described herein it can be shown that in this example an N×N HDBE switch fabric will have 3×6N monitoring and control signals for 1×2 or 2×1 switches, and 4×2N(log N−1) monitoring and control signals for 2×2 switches, for a total of 2N×(4 log N+5) monitoring and control signals. In contrast, it can be shown that in this example the use of the detection strategies described above can reduce the number of monitoring and control signals for 1×2 or 2×1 switches to 2×6N, and the number of monitoring and control signals for 2×2 switches to 2×2N×(log N−1), for a total of 2N×(2 log N+4) monitoring and control signals.

FIG. 5A is a plot showing the total number of monitoring and control signals vs. switch fabric size based on the above example HDBE switch fabric. The total number of monitoring and control signals without the use of the detection strategies described herein is shown at 500 and the total number of monitoring and control signals with detection in accordance with an embodiment of the present invention is shown at 502. As illustrated in FIG. 5A, the use of the detection strategies described above can potentially provide a significant reduction in the total number of monitoring and control signals routed between the controllers and switching elements of the switch fabric.

FIG. 5B is a plot based on the plot of FIG. 5A showing the percent reduction in the number of monitoring and control signals vs. switch fabric size. The reduction in the total number of monitoring and control signals with detection in accordance with an embodiment of the present invention is shown at 504 in FIG. 5B. As illustrated in the Figure, an average reduction of ˜42% may be possible for schemes employing switching elements that utilize detectors as described above, with greater than a 45% reduction potentially possible on larger sized switch fabrics.

Although the potential improvements illustrated in FIGS. 5A and 5B are in the context of an HDBE architecture for AON, similar improvements may also be applicable to other switch architectures including High Throughput Computing (HTC), Data Center (DC) or other individual control modules, such as an optical interposer.

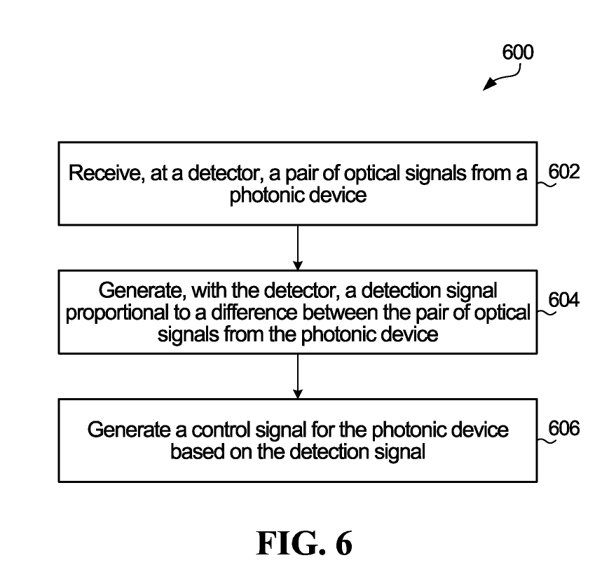

FIG. 6 is a flowchart of an example method. The method 600 relates to control for a photonic device, and includes receiving, at a detector, a pair of optical signals from a photonic device, at 602. The detector generates a detection signal proportional to a difference between the pair of optical signals from the photonic device at 604. A control signal for the photonic device based on the detection signal is generated at 606.

The example method 600 is illustrative of an example embodiment. Various ways to perform the illustrated operations, as well as examples of other operations that may be performed, are described herein. Further variations may be or become apparent.

For example, in some embodiments, the photonic device may be a Mach-Zehnder Interferometer (MZI) based photonic device that has a pair of optical signal path arms, and a controllable phase shifter in at least one of the optical signal path arms. In such cases, generating a control signal at 606 may include generating control signal(s) for the controllable phase shifter(s) of the MZI based photonic device.

In some cases, the MZI based photonic device may be configured as a Variable Optical Attenuator (VOA) with an optical input and an optical output. In these cases, generating the control signal(s) may include adjusting the control signal(s) to adjust the relative phase shift between the optical signal path arms to control optical attenuation between the first optical input and the first optical output.

In another embodiment, the detection signal generated by the detector at 604 is a first detection signal, and the method 600 further includes generating, with a second detector, a second detection signal proportional to a difference between a second pair of optical signals from the photonic device. In such cases, generating a control signal at 606 may involve generating at least one control signal based on the first detection signal and the second detection signal.

In some cases where the photonic device is an MZI based photonic device, the MZI based photonic device may be configured as a 1×2 optical switch with a first optical input, a first optical output and a second optical output. In some such cases, the first detector is coupled between the first optical input and the first optical output to generate the first detection signal proportional to a difference between a first optical input signal from the first optical input and a first optical output signal from the first optical output. Similarly, the second detector may be coupled between the first optical input and the second optical output to generate the second detection signal proportional to a difference between the first optical input signal from the first optical input and a second optical output signal from the second optical output.

In some cases, where the photonic device is configured as a 1×2 optical switch, the method 600 further includes selectively switching the 1×2 optical switch between an up-state and a down-state by adjusting the at least one control signal based on the first detection signal to operate the 1×2 optical switch in the up-state, and adjusting the at least one control signal based on the second detection signal to operate the 1×2 optical switch in the down-state.

In some cases the photonic device may be a 2×2 optical switch with a first optical input, a first optical output, a second optical input and a second optical output. In some such cases, the first detector is coupled between the first optical input and the first optical output to generate the first detection signal proportional to a difference between a first optical input signal from the first optical input and a first optical output signal from the first optical output. Similarly, the second detector may be coupled between the second optical input and the second optical output to generate the second detection signal proportional to a difference between a second optical input signal from the second optical input and a second optical output signal from the second optical output.

In some cases, where the photonic device is configured as a 2×2 optical switch, the method 600 further includes selectively switching the 2×2 optical switch between a bar-state and a cross-state by adjusting the at least one control signal based on the first detection signal and/or the second detection signal to operate the 2×2 optical switch in the bar-state, and adjusting the at least one control signal based on a difference between the first detection signal and the second detection signal to operate the 2×2 optical switch in the cross-state.

In another embodiment, generating the detection signal with the detector at 604 includes tapping off a portion of a first optical signal from the photonic device onto a first optical signal path to the detector, and tapping off a portion of a second optical signal from the photonic device onto a second optical signal path to the detector. In this case, generating the detection signal with the detector at 606 includes generating a detection signal that is proportional to a difference between the tapped off portion of the first optical signal and the tapped off portion of the second optical signal.

In some cases, the method 600 may further include delaying the tapped off portion of the first optical signal relative to the tapped off portion of the second optical signal to at least partially account for a delay between the first optical signal and the second optical signal.

Methods as disclosed herein could be performed or implemented in All Optical Network equipment, such as a multi-channel optical switch, for example. However, embodiments of the present invention are not limited to AON applications, and are more generally applicable to any application involving control of photonic devices.

Numerous modifications and variations of the present application are possible in light of the above teachings. It is therefore to be understood that within the scope of the appended claims, the application may be practised otherwise than as specifically described herein. What has been described is merely illustrative of the application of principles of embodiments of the present disclosure. Other arrangements and methods can be implemented by those skilled in the art. Although the present disclosure refers to specific features and embodiments, various modifications and combinations can be made. The specification and drawings are, accordingly, to be regarded simply as an illustration of embodiments of the invention as defined by the appended claims, and are contemplated to cover any and all modifications, variations, combinations, or equivalents. Thus, it should be understood that various changes, substitutions and alterations can be made herein without departing from the invention as defined by the appended claims.

Moreover, the scope of the present application is not intended to be limited to particular embodiments of any process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments disclosed herein may be utilized. Accordingly, the appended claims are intended to include within their scope such processes, machines, manufacture, compositions of matter, means, methods, or steps.

In addition, although described primarily in the context of methods, apparatus and equipment, other implementations are also contemplated, such as in the form of instructions stored on a non-transitory computer-readable medium, for example.

1. An apparatus comprising:
a photonic device; and
a detector, operatively coupled to the photonic device, configured to receive a pair of optical signals from the photonic device and generate a detection signal proportional to a difference between the pair of optical signals,
the photonic device having a control input to receive a control signal based on the detection signal.

2. The apparatus of claim 1, further comprising:
a controller, operatively coupled to the detector and the control input of the photonic device, configured to receive the detection signal and generate the control signal for the photonic device based on the detection signal.

3. The apparatus of claim 2, wherein:
the photonic device is a Mach-Zender Interferometer (MZI) based photonic device comprising a first optical signal path arm and a second optical signal path arm; and
the first optical signal path arm comprises a controllable optical phase shifter, the controllable optical phase shifter having a control input operatively coupled to the control input of the photonic device to receive the control signal from the controller, the controllable optical phase shifter being configured to introduce a phase shift along the first optical signal path arm based on the control signal.

4. The apparatus of claim 2, wherein the photonic device is a Variable Optical Attenuator (VOA) with an optical input and an optical output, and the controller figured to generate the control signal to control optical attenuation between the optical input and the optical output of the VOA.

5. The apparatus of claim 2, wherein the detector is a first detector, the pair of optical signals from the photonic device is a first pair of optical signals, the detection signal from the first detector is a first detection signal, and the apparatus further comprises:
a second detector, operatively coupled to the photonic device, configured to receive a second pair of optical signals from the photonic device and generate a second detection signal proportional to a difference between the second pair of optical signals,
wherein the controller is operatively coupled to the second detector to receive the second detection signal, and is configured to generate the control signal based on the first detection signal and the second detection signal.

6. The apparatus of claim 5, wherein the photonic device comprises a first optical input, a first optical output and a second optical output, and is configured as a 1×2 optical switch.

7. The apparatus of claim 6, wherein:
the first detector is operatively coupled between the first optical input and the first optical output, and is configured to generate the first detection signal proportional to a difference between a first optical input signal at the first optical input and a first optical output signal at the first optical output; and
the second detector is operatively coupled between the first optical input and the second optical output, and is configured to generate the second detection signal proportional to a difference between the first optical input signal at the first optical input and a second optical output signal at the second optical output.

8. The apparatus of claim 7, wherein:
to operate the 1×2 optical switch in an up-state, the controller is configured to adjust the control signal based on the first detection signal; and
to operate the 1×2 optical switch in a down-state, the controller is configured to adjust the control signal based on the second detection signal.

9. The apparatus of claim 5, wherein the photonic device comprises a first optical input, a second optical input, a first optical output and a second optical output, and is configured as a 2×2 optical switch.

10. The apparatus of claim 9, wherein:
the first detector is operatively coupled between the first optical input and the first optical output, and is configured to generate the first detection signal proportional to a difference between a first optical input signal at the first optical input and a first optical output signal at the first optical output; and
the second detector is operatively coupled between the second optical input and the second optical output, and is configured to generate the second detection signal proportional to a difference between a second optical input signal at the second optical input and a second optical output signal at the second optical output.

11. The apparatus of claim 10, wherein:
to operate the 2×2 optical switch in a bar-state, the controller is configured to adjust the control signal based on the first detection signal and/or the second detection signal; and
to operate the 2×2 optical switch in a cross-state, the controller is configured to adjust the control signal based on a difference between the first detection signal and the second detection signal.

12. The apparatus of claim 9, wherein:
the first detector is operatively coupled between the first optical input and the second optical input, and is configured to generate the first detection signal proportional to a difference between a first optical input signal at the first optical input and a second optical input signal at the second optical input; and
the second detector is operatively coupled between the first optical output and the second optical output, and is configured to generate the second detection signal proportional to a difference between a first optical output signal at the first optical output and a second optical output signal at the second optical output.

13. The apparatus of claim 1, wherein the detector comprises a first photodetector and a second photodetector, the first photodetector and the second photodetector being arranged in a back-to-back biasing arrangement with the detection signal being taken as an output current at a point between the first photodetector and the second photodetector with the output current proportional to the difference between photocurrents generated by the first and second photodetectors.

14. The apparatus of claim 13, further comprising:
a first optical tap, operatively coupled to the photonic device and the first photodetector;
a second optical tap, operatively coupled to the photonic device and the second photodetector; and
a delay element in an optical signal path between the first optical tap and the first photodetector.

15. A photonic integrated circuit (PIC) element comprising the apparatus according to claim 1.

16. A multi-channel optical switch comprising:
a multi-channel optical switch fabric comprising a plurality of PIC elements according to claim 15.

17. A method of controlling a photonic device, the method comprising:
receiving, at a detector, a pair of optical signals from a photonic device;
generating, with the detector, a detection signal proportional a difference between the pair of optical signals from the photonic device; and
generating a control signal for the photonic device based on the detection signal.

18. The method of claim 17, further comprising:
prior to receiving, at the detector, the pair of optical signals, delaying one optical signal of the pair of optical signals.

19. The method of claim 17, wherein:
the photonic device is a Mach-Zehnder Interferometer (MZI) based photonic device having a first optical signal path arm and a second optical signal path arm, with a controllable phase shifter in at least one of the optical signal path arms; and
generating a control signal for the photonic device comprises generating at least one control signal to control the controllable phase shifter(s) to introduce a relative phase shift between the optical signal path arms.

20. The method of claim 17, wherein the detector is a first detector, the pair of optical signals from the photonic device is a first pair of optical signals, the detection signal from the first detector is a first detection signal, and the method further comprises:
receiving, at a second detector, a second pair of optical signals from the photonic device;
generating, with the second detector, a second detection signal proportional to a difference between the second pair of optical signals from the photonic device,
wherein generating the control signal comprises generating the control signal based on the first detection signal and the second detection signal.

21. The method of claim 20, wherein:
the photonic device is configured as a 1×2 optical switch with a first optical input, a first optical output and a second optical output;
generating the first detection signal comprises generating, with the first detector, the first detection signal proportional to a difference between a first optical input signal from the first optical input and a first optical output signal from the first optical output; and
generating the second detection signal comprises generating, with the second detector, the second detection signal proportional to a difference between the first optical input signal from the first optical input and a second optical output signal from the second optical output.

22. The method of claim 21, further comprising selectively switching the 1×2 optical switch between an up-state and a down-state by:
adjusting the control signal based on the first detection signal to operate the 1×2 optical switch in the up-state; and
adjusting the control signal based on the second detection signal to operate the 1×2 optical switch in the down-state.

23. The method of claim 20, wherein:
the photonic device is configured as a 2×2 optical switch with a first optical input, a first optical output, a second optical input and a second optical output;
generating the first detection signal comprises generating, with the first detector, the first detection signal proportional to a difference between a first optical input signal from the first optical input and a first optical output signal from the first optical output; and
generating the second detection signal comprises generating, with the second detector, the second detection signal proportional to a difference between a second optical input signal from the second optical input and a second optical output signal from the second optical output.

24. The method of claim 23, further comprising selectively switching the 2×2 optical switch between a bar-state and a cross-state by:
adjusting the control signal based on the first detection signal and/or the second detection signal to operate the 2×2 optical switch in the bar-state; and
adjusting the control signal based on a difference between the first detection signal and the second detection signal to operate the 2×2 optical switch in the cross-state.
